(19) United States
(12) Patent Application Publication
(10) Pub. No.: US 2022/0056237 A1
(43) Pub. Date: Feb. 24, 2022

(54) METHOD OF MANUFACTURING DECORATION FOIL AND RELEASE LAYER AND ADHESIVE LAYER OF DECORATION FOIL, AND DECORATION FOIL MANUFACTURED BY THE SAME

(71) Applicant: UNIVACCO TECHNOLOGY INC., TAINAN CITY (TW)

(72) Inventors: KUO-LUNG TSAI, TAINAN CITY (TW); HSIEN-CHANG LEE, TAINAN CITY (TW); HSIEN-YIN TSAI, TAINAN CITY (TW); MING-CHIEH KUO, TAINAN CITY (TW); CHIEN-LIANG KUO, TAINAN CITY (TW)

(21) Appl. No.: 17/398,286

(22) Filed: Aug. 10, 2021

(30) Foreign Application Priority Data
Aug. 20, 2020 (TW) 109128417

(51) Int. Cl. C08J 11/22; C09J 7/40; C09J 7/38; C09J 7/22; C09J 7/20

(52) U.S. Cl. CPC C08J 11/22; C09J 7/401; C09J 7/38; C09J 7/22; C09J 2475/005; C08J 2367/02; C09J 2301/122; C09J 2475/00; C09J 7/201

(57) ABSTRACT

A method of manufacturing decoration foils and a release layer and an adhesive layer of the decoration foil, and decoration foils manufactured by the same are revealed. First take waste containing polyethylene terephthalate (PET) to react with an alcohol and get a first product. Then the first product is allowed to react with a compound containing isocyanate group and polyol to obtain polyurethane (PU) material. The PU material obtained is used for manufacturing at least one of a release layer and an adhesive of decoration foils to get the decoration foil.

### BACKGROUND OF THE INVENTION

### Field of the Invention

The present invention relates to a method for manufacturing decoration foils and a release layer and an adhesive layer of the decoration foil, especially to a method for manufacturing decoration foils and a release layer and an adhesive layer of the decoration foil, and decoration foils manufactured by the same in which waste containing polyethylene terephthalate (PET) is reacted with alcohols to be depolymerized and then products obtained are used to manufacture decoration foils and at least one of a release layer and an adhesive layer of the decoration foil.

### Description of Related Art

The final goal of plastic recycling and reuse is closed-loop recycling which takes the recovered material and use it back in the original manufacturing chain to get new products. However, various types of wastes have different characteristics so that not all wastes can be recycled and reused. Thus the closed-loop recycling is difficult to be achieved. Nowadays recovered material from plastics waste recycling has already been used in products in textile industry. However, applications of plastics waste recycling and reuse in other fields are not as common and so are related research.

Metallic embellishment process involves a heated metal die pressed against a colored foil that touches the desired product to form patterns with metal luster on surface of the products. The decoration foil consists of a base layer, a release layer, a color layer, a metallization layer, and an adhesive layer. During the metallic embellishment use, the adhesive layer is attached to the product to be treated and treated by light or temperature for curing. Thus patterns on the decoration foil are transferred to the surface of the product. Lastly the base layer and the release layer of the decoration foil are removed to complete the metallic embellishment process. Most of the base layer and the release layer are made of polymer and usually discarded as waste and burned after the metallic embellishment process, without being recycled and reused. In research and development field of the decoration foil, closed-loop recycling related projects have not yet been found and it's a pity that the base layer of the decoration foil is discarded, without being reused.

### SUMMARY OF THE INVENTION

Therefore, it is a primary object of the present invention to provide a method of manufacturing at least one of a release layer and an adhesive layer of decoration foils includes the steps of reacting waste containing polyethylene terephthalate (PET) with an alcohol to get a first product, carrying out polymerization by reacting the first product with a compound containing isocyanate group and polyols to obtain polyurethane (PU) material, and manufacturing at least one of a release layer and an adhesive layer of decoration foils by the PU material.

It is another object of the present invention to provide a method of manufacturing decoration foils which includes the steps of taking a base layer, disposing a release layer over the base layer, arranging at least one color layer over the release layer, mounting a metallization layer over the color layer, and disposing an adhesive layer over the metallization layer. At least one of the release layer and the adhesive layer is made of PU material manufactured by waste containing PET.

It is a further object of the present invention to provide a decoration foil in which at least one of a release layer and an adhesive layer is manufactured by the method mentioned above.

Preferably, the first product is selected from the group consisting of Bis(2-hydroxyethyl) terephthalate (BHET) oligomer, BHET monomer, Bis(diethylene glycol) terephthalate (BDEGT) oligomer, BDEGT monomer, Bis(4-hydroxybutylene) terephthalate (BHBT) oligomer, BHBT monomer, and a combination thereof.

Preferably, the alcohol includes at least two hydroxyl groups. For example, the alcohol includes 2-6 hydroxyl groups.

Preferably, the alcohol is ethylene glycol, diethylene glycol, or 1,4-butanediol (BDO).

Preferably, the waste containing PET includes PET bottle waste and decoration foil waste.

Preferably, the reaction of the waste containing PET with the alcohol is catalyzed by a catalyst which is an organometallic salt including aluminium isopropoxide, zinc acetate dihydrate (ZnAc₂.2H₂O), Manganese(II) acetate (MnAc₂.4H₂O), and lead (II) acetate trihydrate (PbAc₂.3H₂O).

Thereby the present method uses waste containing PET to react with alcohols and then products obtained are subjected to react with a compound containing an isocyanate group for polymerization to get PU material. The PU material obtained is applied to manufacturing at least one of a release layer and an adhesive layer of decoration foils for achieving a closed-loop recycling which not only reduces the amount of waste disposed, but also recovers and reuses recyclables. Thus value chain sustainability of decoration foil industry is further realized.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing decoration foil produced by waste containing PET of an embodiment according to the present invention;

FIG. 2 shows mechanical property curves of PU manufactured by using decoration foil waste of an embodiment according to the present invention;

FIG. 3(A)-FIG. 3(C) are photos of patterns transferred from a decoration foil with a release layer made from decoration foil waste of an embodiment according to the present invention;

FIG. 4 (A)-FIG. 4(C) are photos of patterns transferred from a decoration foil having an adhesive layer made from decoration foil waste of an embodiment according to the present invention; and

FIG. 5(A)-FIG. 5(C) are photos of patterns transferred from a decoration foil with a release layer and an adhesive layer both made from decoration foil waste of an embodiment according to the present invention.

### DETAILED DESCRIPTION OF THE PREFERRED EMBODIMENT

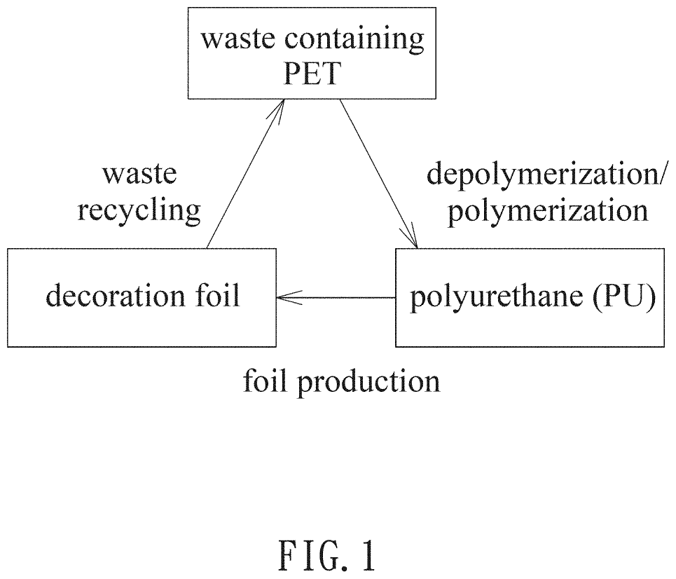

Refer to FIG. 1, the present invention uses waste containing polyethylene terephthalate (PET) to manufacture decoration foils. The waste containing PET is depolymerized and then repolymerized to obtain polyurethane (PU) material which is applied to production of decoration foils such as manufacturing a release layer and an adhesive layer of the decoration foil. After producing the decoration foil and metallic embellishment, waste generated such as a base layer of the decoration foil contains PET so that the waste can be used as material for manufacturing PU. Thereby a closed-loop recycling is formed.

A method of manufacturing PU material by using waste containing PET includes the following steps. First take waste containing PET to react with alcohols and get a first product. Then the first product is subjected to react with polyol and a compound containing isocyanate group (NCO⁻) such as isocyanate to get PU material. Next use the PU material to manufacture a release layer or an adhesive layer of decoration foils. The alcohol includes at least two hydroxyl groups while 2-6 hydroxyl groups are preferred.

As to applications of the present invention, please refer to the following embodiments.

### 1. Manufacturing PU Material by Using Waste Containing PET

### Embodiment 1

In this embodiment, the waste containing PET is a base layer of decoration foils. The base layer of decoration foils is allowed to react with excessive of ethylene glycol (EG) and zinc acetate is added as a catalyst. The amount of zinc acetate added is preferably 0.2 weight percentage (wt %) of the base layer of decoration foils. Place the reactants into a container, seal the container, and introduce nitrogen gas into the container to prevent oxidation. Then depolymerization is carried out at 190-240° C. under normal pressure for 2-4 hours to decompose the base layer of decoration foils. The preferred reaction temperature is 200° C. After the reaction, the container is heated up to 260° C. to remove excess EG by vacuum evaporation. The product obtained can be further purified by hot water. During the process, BHET oligomers are first obtained and continuingly reacting with EG to get a product containing BHET dimers and BHET monomers with the yield rate larger than 57%. In this embodiment, molecular weight of the BHET monomer manufactured is 200-300 Da.

Next the BHET oligomer mentioned above is subjected to react with compounds containing isocyanate group to get a PU pre-polymer. In this embodiment, the compound containing isocyanate group is isocyanate. Then the PU pre-polymer reacts with subsequent BHET monomer obtained to get PU material required. The BHET monomer is used as chain extender for the PU pre-polymer.

### Embodiment 2

Mix a base layer of decoration foils having main component of PET with excessive of diethylene glycol (DEG) and add zinc acetate as a catalyst. The amount of zinc acetate added is preferably 0.7 weight percentage (wt %) of the base layer of decoration foils. Place the reactants into a container, seal the container, and introduce nitrogen gas into the container to prevent oxidation. Then the base layer of decoration foils is decomposed at 190-240° C. under normal pressure for 2-4 hours. The preferred reaction temperature is 220° C. After remove excess DEG, the main products obtained which include BDEGT monomer and its oligomer can be directly used to manufacture PU, without any separation and purification steps.

Next the BDEGT monomer and its oligomer obtained are subjected to react with compounds containing isocyanate group to get a PU pre-polymer. In this embodiment, the compound containing isocyanate group is isocyanate. Then a chain extender such as DEG, EG, or 1,4-butanediol (1,4-BDO) is added to obtain PU material.

### Embodiment 3

Mix a base layer of decoration foils having main component of PET with 1,4-BDO and then add zinc acetate as a catalyst. Place the reactants into a container, seal the container, and introduce nitrogen gas into the container to prevent oxidation of 1,4-BDO. Then the base layer of decoration foils is decomposed at 220° C. under normal pressure for 2-6 hours. After remove excess 1,4-BDO, the main products obtained which include BHBT monomer and its oligomer can be directly used to manufacture PU, without any separation and purification steps.

According to results of the above experiments, different intermediates and final products are obtained once different types of alcohols are used to react with the waste containing PET, such as a base layer of decoration foils with main component of PET. Since the amount and the purity of PET contained in the base layer of decoration foils are extremely high, the base layer can be directly reacted with alcohols after being torn off, without any pretreatment. Thus the intermediate and end products obtained have quite high purity, able to be used for manufacturing different products, synthesis of other polymer materials, or even being applied to production of decoration foils.

The PU material manufactured above is mixed with new PU material in a ratio of 5-100 weight percentage (5-100 wt %) to the rest weight percentage to get a hybrid PU material. The new PU material here means PU polyol oligomers those are not obtained by depolymerization and reproduction of the waste containing PET. The above hybrid PU material is called the first type of hybrid PU in the following specification.

Moreover, the BHET oligomer, BDEGT oligomer, or BHBT oligomer obtained during depolymerization of the decoration foil waste containing PET in the embodiments 1-3 is mixed with polyester polyol oligomers in a ratio of 5-100 weight percentage (5-100 wt %) to the rest weight percentage and then reacted with isocyanate to produce PU. In the following embodiments, the PU material manufactured by the present method is called the second type of hybrid PU.

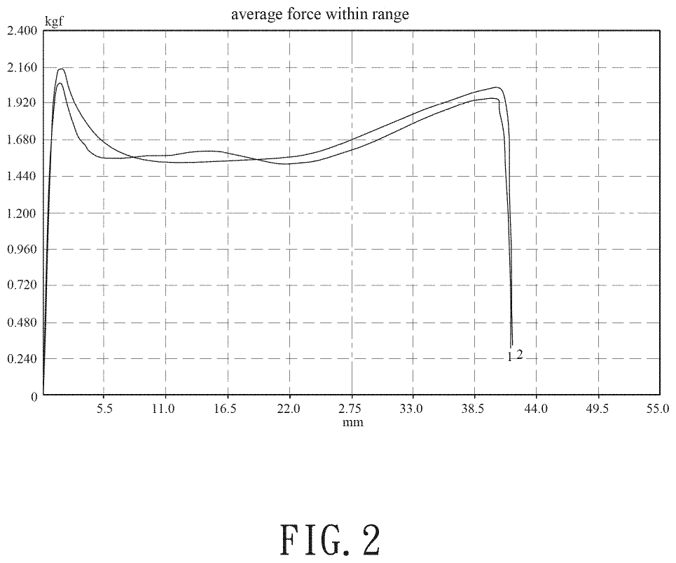

Refer to FIG. 2, two stress-strain curves of the second type of hybrid PU which are measured by a tensile test machine and used for showing stress modulus during material deformation are revealed. The two curves show test results of the PU material produced at two times. According to the FIG. 2, the second type of hybrid PU produced at different times has similar properties. This means the PU material manufactured by using decoration foil waste according to the present method has good reproducibility.

### 2. Decoration Foil Waste Applied to Manufacturing Decoration Foils

A method of manufacturing decoration foils includes a plurality of steps. First take a base layer. Then dispose a release layer over the base layer, arrange at least one color layer over the release layer, mount a metallization layer over the color layer, and dispose an adhesive layer over the metallization layer. In the following embodiments, at least one of the release layer and the adhesive layer of the decoration foil is made from the second type of hybrid PU mentioned above.

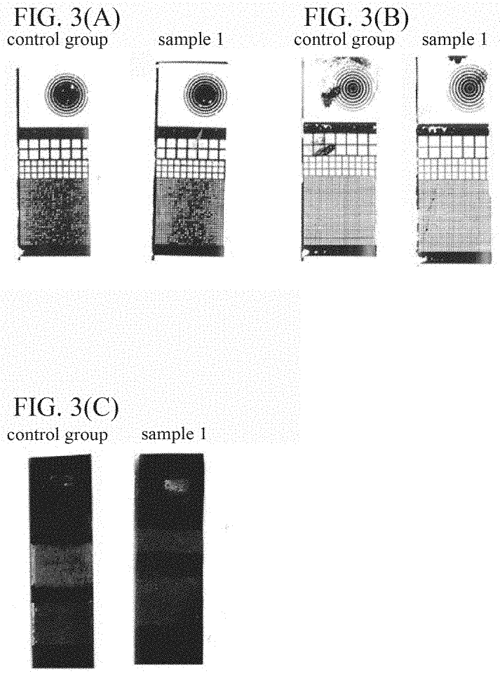

FIG. 3(A), FIG. 3(B), and FIG. 3(C) show decoration transfer results of definition, saturation, printability and adhesion of patterns transferred from the decoration foil by metallic embellishment respectively. The control group is a commercial product while a release layer of the sample 1 of the decoration foil is made from the second type of hybrid PU. According to FIG. 3(A)-FIG. 3(C), there is no significant difference in definition, saturation, printability and adhesion of the patterns printed on the control group and the sample 1.

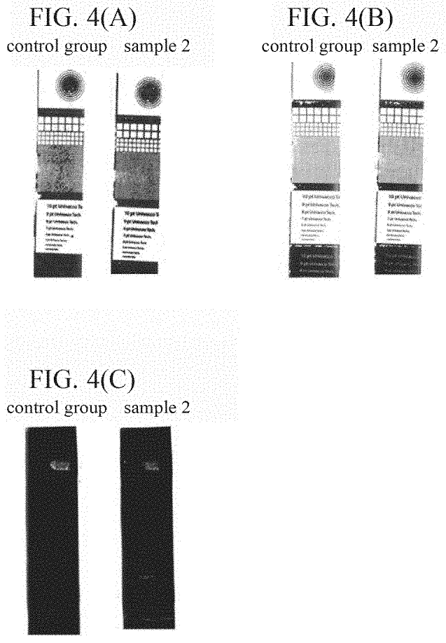

FIG. 4(A), FIG. 4(B), and FIG. 4(C) are also decoration transfer results of definition, saturation, printability and adhesion of patterns transferred from the decoration foil by metallic embellishment respectively. The control group is a commercial product while an adhesive layer of the sample 2 of the decoration foil is made from the second type of hybrid PU. According to FIG. 4(A)-FIG. 4(C), there is no significant difference in definition, saturation, printability and adhesion of the patterns printed on the control group and the sample 2.

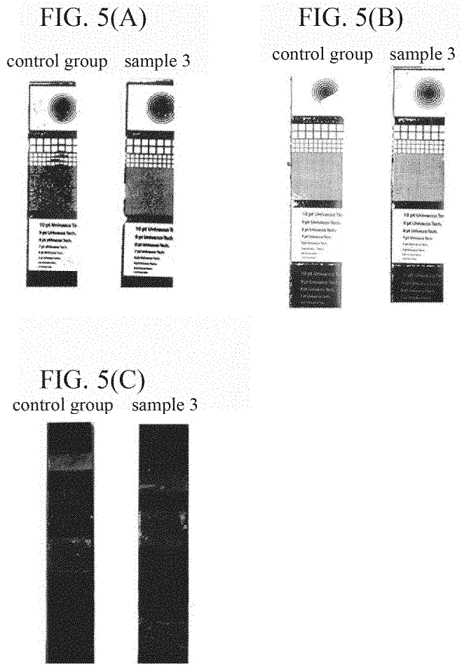

Similarly, FIG. 5(A), FIG. 5(B), and FIG. 5(C) are decoration transfer results of definition, saturation, printability and adhesion of patterns transferred from the decoration foil by metallic embellishment respectively. The control group is a commercial product while an adhesive layer and a release layer of the sample 3 of the decoration foil are made from the second type of hybrid PU. According to FIG. 5(A)-FIG. 5(C), there is no significant difference in definition, saturation, printability and adhesion of the patterns printed on the control group and the sample 3.

In summary, the present method allows the decoration foil waste containing PET to react with alcohols for depolymerization and then products obtained after the reaction are applied to producing PU material. The PU material produced is further used to manufacture the release layer and the adhesive layer of the decoration foil. Through experiments, it is proved that the difference between the decoration foil manufactured by the present method and the product available on the market is extremely small. The present method not only achieves closed loop recycling but also realizes value chain sustainability of decoration foil industry.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A method of manufacturing at least one of a release layer and an adhesive layer of decoration foils comprising the steps of:
reacting waste containing polyethylene terephthalate (PET) with an alcohol to get a first product,
carrying out polymerization by reacting the first product with a compound containing isocyanate group and polyol to obtain polyurethane (PU) material, and
manufacturing at least one of a release layer and an adhesive layer of decoration foils by the PU material.

2. The method as claimed in claim 1, wherein the first product is selected from the group consisting of Bis(2-hydroxyethyl) terephthalate (BHET) oligomer, BHET monomer, Bis(diethylene glycol) terephthalate (BDEGT) oligomer, BDEGT monomer, Bis(4-hydroxybutylene)terephthalate (BHBT) oligomer, BHBT monomer, and a combination thereof.

3. The method as claimed in claim 1, wherein the alcohol includes at least two hydroxyl groups.

4. The method as claimed in claim 3, wherein the alcohol includes 2-6 hydroxyl groups.

5. The method as claimed in claim 1, wherein the compound containing isocyanate group is isocyanate.

6. The method as claimed in claim 1, wherein the waste containing PET includes PET bottle waste and decoration foil waste.

7. A method of manufacturing decoration foils comprising the steps of taking a base layer, disposing a release layer over the base layer, arranging at least one color layer over the release layer, mounting a metallization layer over the color layer, and disposing an adhesive layer over the metallization layer; wherein at least one of the release layer and the adhesive layer is made of PU material manufactured by waste containing PET.

8. The method as claimed in claim 7, wherein the PU material is manufactured by a method comprising the steps of reacting the waste containing PET with an alcohol to get a first product, and carrying out polymerization by reacting the first product with a compound containing isocyanate group and polyol to obtain the PU material.

9. The method as claimed in claim 8, wherein the first product is selected from the group consisting of Bis(2-hydroxyethyl) terephthalate (BHET) oligomer, BHET monomer, Bis(diethylene glycol) terephthalate (BDEGT) oligomer, BDEGT monomer, Bis(4-hydroxybutylene)terephthalate (BHBT) oligomer, BHBT monomer, and a combination thereof.

10. The method as claimed in claim 8, wherein the alcohol includes at least two hydroxyl groups.

11. The method as claimed in claim 10, wherein the alcohol includes 2-6 hydroxyl groups.

12. The method as claimed in claim 8, wherein the compound containing isocyanate group is isocyanate.

13. The method as claimed in claim 7, wherein the waste containing PET includes PET bottle waste and decoration foil waste.

14. A decoration foil comprising a base layer, a release layer, at least one color layer, a metallization layer, and an adhesive layer arranged in turn; wherein at least one of the release layer and the adhesive layer is made of PU material manufactured by waste containing PET.

15. The decoration foil as claimed in claim 14, wherein the PU material is manufactured by a method comprising the steps of reacting the waste containing PET with an alcohol to get a first product, and carrying out polymerization by reacting the first product with a compound containing isocyanate group and polyol to obtain the PU material.

16. The decoration foil as claimed in claim 15, wherein the first product is selected from the group consisting of Bis(2-hydroxyethyl) terephthalate (BHET) oligomer, BHET monomer, Bis(diethylene glycol) terephthalate (BDEGT) oligomer, BDEGT monomer, Bis(4-hydroxybutylene)terephthalate (BHBT) oligomer, BHBT monomer, and a combination thereof.

17. The decoration foil as claimed in claim 15, wherein the alcohol includes at least two hydroxyl groups.

18. The decoration foil as claimed in claim 17, wherein the alcohol includes 2-6 hydroxyl groups.

19. The decoration foil as claimed in claim 15, wherein the compound containing isocyanate group is isocyanate.

20. The decoration foil as claimed in claim 14, wherein the waste containing PET includes PET bottle waste and decoration foil waste.
